(19) United States
(12) Patent Application Publication
(10) Pub. No.: US 2010/0266235 A1
(43) Pub. Date: Oct. 21, 2010

(54) PLANAR LIGHTWAVE APPARATUS

(76) Inventors: Ying-Tso LIN, Taipei (TW); Shih-Jung Chang, Taipei (TW)

Correspondence Address: HDLS Patent & Trademark Services, P.O. BOX 220746, CHANTILLY, VA, 20153-0746, US

(21) Appl. No.: 11/850,800

(22) Filed: Sep. 6, 2007

(51) Int. Cl. G02B 6/125

(52) U.S. Cl. 385/14

(57) ABSTRACT

A planar lightwave apparatus includes a planar lightwave circuit (PLC) chip, a fiber array block (FAB) assembled to one face of the PLC chip, and a casing with one opening, wherein one end of the FAB extends out of the opening of the casing. The PLC chip includes an input optical waveguide, a plurality of output optical waveguides and a beam splitter for connecting the input optical waveguide and the output optical waveguides. The input optical waveguide and the output optical waveguides are arranged on the same face of the PLC chip. Therefore, the PLC chip needs only one-time coupling process with the FAB. The coupling process can be simplified and the packaging cost is reduced.

### BACKGROUND OF THE INVENTION

1. Field of the Invention

The present invention relates to a planar lightwave apparatus, especially to a planar lightwave apparatus with simplified manufacture process.

2. Description of Prior Art

Fiber optic communication is attractive for the applications of long haul telecommunication, Internet service and multimedia communication because fiber optic communication is immune from electromagnetic interference and has high bandwidth and low loss. Therefore, the conventional copper wire is gradually replaced by optical fibers, especially in telecommunication network, data network or cable television network.

Optical splitter is important device in fiber optic communication system. In industrialized countries such as European countries, USA and Japan, Fiber to the Home (FTTH) service is popular. Therefore, Planar Lightwave Circuit Splitter (PLC Splitter) is extensively used in Passive Optical Network (PON) for branching optical wave.

The current PLC splitter is packaged in single-in and multiple-out arrangement, for example, the PLC splitter is packaged in 1×8, 1×16 or 1×32 arrangement. FIG. 1 shows the schematic view of a related art PLC splitter 10 in a PLC Splitter apparatus. The PLC splitter 10 comprises a single-core fiber 104, a PLC chip 100 and a fiber array block (FAB) 102, wherein the single-core fiber 104 and the FAB 102 are arranged on two opposite sides of the PLC chip 100, respectively.

The single-core fiber 104 comprises a substrate (not labeled) and an optical fiber 104a arranged on the substrate. The FAB 102 comprises a substrate (not labeled) and a plurality of parallel optical fibers 102a arranged on the substrate. The PLC chip 100 comprises a substrate (not labeled), an input end 100a arranged on one side of the substrate, a plurality of output ends 100b arranged on another side of the substrate, and an optical splitter 100c for bridging the input end 100a and the plurality of output ends 100b. In this way, the light input through the single-core fiber 104 can be branched to the FAB 102.

FIG. 2A and FIG. 2B are perspective view and sectional view for showing the PLC splitter 10 is packaged into a PLC splitter apparatus (not labeled). The PLC splitter 10 is packaged into a sealing case 120. The sealing case 120 comprises two openings (not labeled) on two opposite faces thereof, wherein one opening is for the single-core fiber 104 and the other opening is for the FAB 102. With reference to these two drawings, after the PLC splitter 10 is placed into the sealing case 120, the openings are sealed with glue 122 to protect the PLC splitter 10 in hazardous environment.

However, in above-mentioned PLC splitter apparatus, the PLC chip 100 should be precisely coupled to the single-core fiber 104 and the FAB 102 on two opposite sides thereof, the process is complicated and the yield is low. Moreover, the sealing case 120 has two openings and more glue 122 is required to seal the two openings. The manufacture cost is high.

### SUMMARY OF THE INVENTION

It is an object of the present invention to provide a planar lightwave apparatus integrating the single-core fiber and the fiber array block (FAB) on the same side to reduce packaging and coupling complication.

It is another object of the present invention to provide a planar lightwave apparatus with reduced cost for sealing the opening in the sealing case.

Accordingly, the present invention provides a planar lightwave apparatus including a planar lightwave circuit (PLC) chip, a fiber array block (FAB) assembled to one face of the PLC chip, and a casing with one opening, wherein one end of the FAB extends out of the opening of the casing. The PLC chip includes an input optical waveguide, a plurality of output optical waveguides and a beam splitter for connecting the input optical waveguide and the output optical waveguides. The input optical waveguide and the output optical waveguides are arranged on the same face of the PLC chip. Therefore, the PLC chip needs only one-time coupling process with the FAB. The coupling process can be simplified and the packaging cost is reduced.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows the schematic view of a related art PLC splitter.

FIG. 2A is a perspective view showing that the PLC splitter in FIG. 1 is packaged into a PLC splitter apparatus.

FIG. 2B is a sectional view showing that the PLC splitter in FIG. 1 is packaged into a PLC splitter apparatus.

FIG. 3 shows the schematic view of the PLC device according to the present invention.

FIG. 4A shows the perspective view of the PLC apparatus according to the present invention.

FIG. 4B shows the top view of the PLC apparatus according to the present invention.

FIG. 4C shows the sectional view of the PLC apparatus according to the present invention.

FIG. 5 shows a sectional view for PLC apparatus according to another preferred embodiment of the present invention.

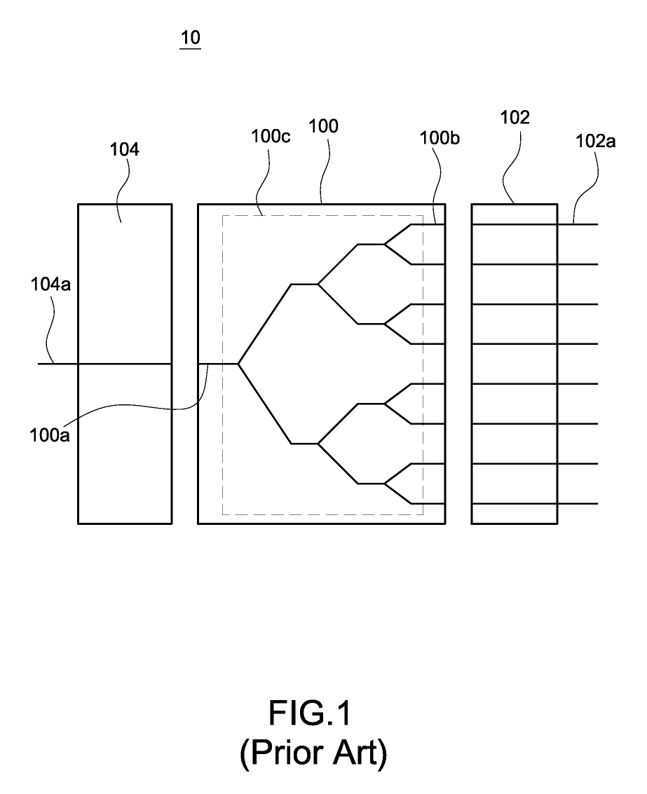

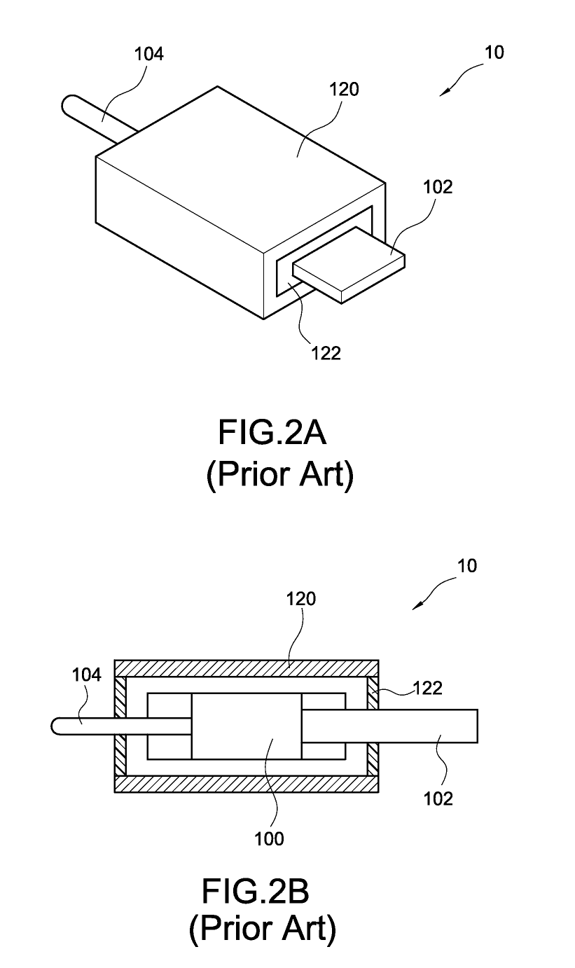

### DETAILED DESCRIPTION OF THE INVENTION

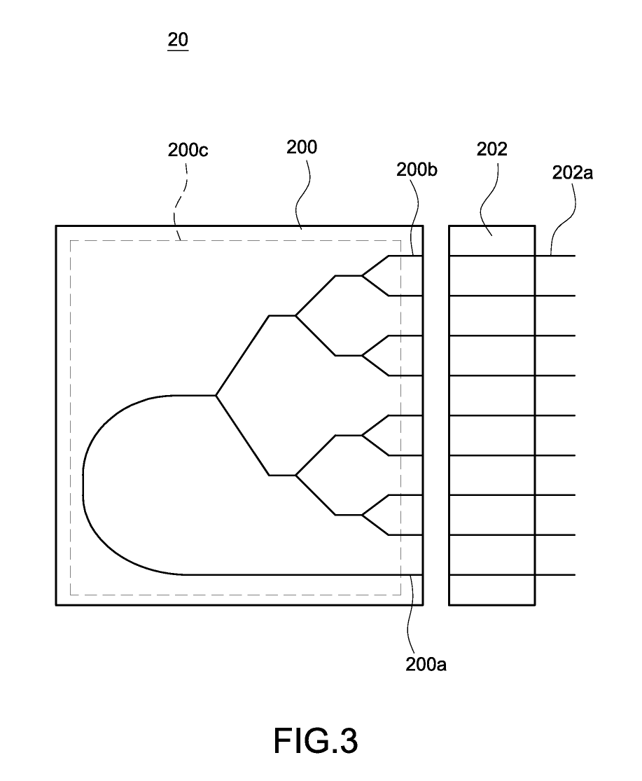

FIG. 3 shows the schematic view of the PLC device 20 according to the present invention. The PLC device 20 mainly comprises a single-sided 1×N PLC chip 200 and a fiber array block (FAB) 202 arranged on one side of the PLC chip 200. The PLC chip 200 comprises an input end 200a arranged on one side thereof, a plurality of output ends 200b arranged on the same side and an optical splitter 200c for bridging the input end 200a and the plurality of output ends 200b. The optical splitter 200c comprises a bending portion (not labeled) such that the input end 200a and the output ends 200b can be arranged at the same side of the PLC chip 200.

The FAB 202 comprises a substrate (not labeled) and a plurality of parallel optical fibers 202a on the substrate, wherein the plurality of parallel optical fibers 202a are coupled to the input end 200a and the output ends 200b of the PLC chip 200. As shown in FIG. 3, in the PLC device 20, only one coupling task is required between the PLC chip 200 and the FAB 202. Therefore, the coupling task is simplified and the yield of the PLC device 20 is enhanced. In above-mentioned FAB 202, the number of the parallel optical fibers 202a is larger than or equal to the total number of the input end 200a and the output ends 200b of the PLC chip 200. Moreover, the separation between two adjacent fibers in the parallel optical fibers 202a is 250 μm or 127 μm. For ease of alignment and manufacture, the separation between adjacent fibers in the input end 200a and the output ends 200b can also be 250 μm or 127 μm. It should be noted that the separation between two adjacent fibers in the parallel optical fibers 202a can be other value, depending on design choice and practical application.

The PLC chip 200 and the FAB 202 are independent devices, which are manufactured separately. Therefore, the PLC chip 200 and the FAB 202 need to be combined by glue. The conventional PLC device comprises a single core fiber, a PLC chip and an FAB; therefore, two faces of the PLC chip require alignment and binding. The PLC device according to the present invention comprises only a PLC chip and an FAB, therefore, only one face of the PLC chip requires alignment and binding. The manufacture cost is advantageously reduced.

Moreover, the above preferred embodiment is exemplified with optical splitter apparatus. The PLC device 20 comprises one input end and N output ends. The concept of the present invention can also be applied to optical combiner apparatus, wherein the PLC device 20 comprises one output end and N input ends.

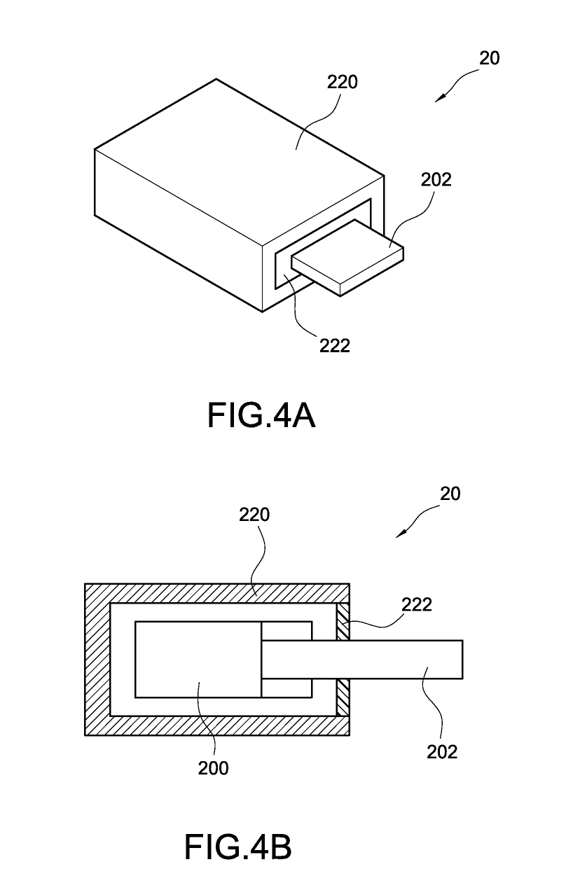

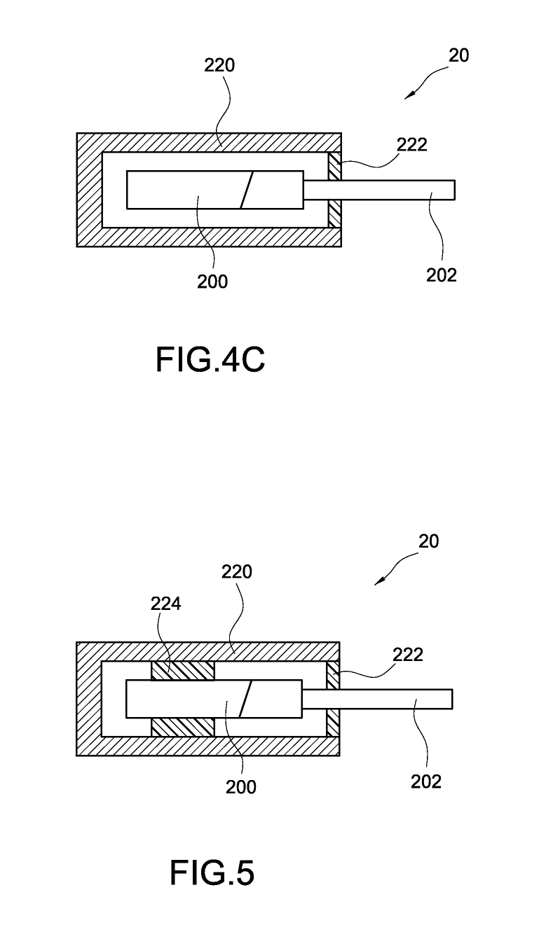

FIG. 4A, FIG. 4B and FIG. 4C show the perspective view, the top view and the sectional view of the PLC apparatus according to the present invention. The PLC device 20 is packaged in a sealing case 220 with only one opening (not labeled). One end of the FAB 202 is exposed out of the sealing case. The opening is sealed by glue 222. With reference to FIG. 5, at least one supporting mount 224 is provided in the sealing case 220 to prevent the PLC chip 200 from the suspending in the case 220 and to prevent damage of the PLC chip 200. The PLC chip 200 is not necessary to be fixed to the supporting mount 224. The number and the position of the supporting mount 224 can be varied to optimally mount the PLC chip 200. Moreover, the supporting mount 224 can be made of resilient material to absorb external shocking force.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A planar lightwave circuit (PLC) device, comprising:
a PLC chip comprising a first optical waveguide, a plurality of second optical waveguides and an optical splitter connecting the first optical waveguide and the second optical waveguides; and
a fiber array block (FAB) connected to one side of the PLC chip;
wherein the first optical waveguide and the plurality of second optical waveguides are arranged on the same side of the PLC chip.

2. The PLC device in claim 1, wherein the FAB comprises a plurality of parallel optical fibers, and the number of the parallel optical fibers is equal to the total number of the first optical waveguide and the second optical waveguides.

3. The PLC device in claim 1, wherein the PLC chip is used as an optical splitter apparatus, and the first optical waveguide is an input end and the second optical waveguides are output ends.

4. The PLC device in claim 1, wherein the PLC chip is used as an optical combiner apparatus, and the first optical waveguide is an output end and the second optical waveguides are input ends.

5. The PLC device in claim 1, wherein two adjacent optical fibers in the first optical waveguide and the second optical waveguides have a predetermined separation.

6. The PLC device in claim 5, wherein two adjacent optical fibers in the parallel optical fibers of the FAB have a separation equal to the predetermined separation.

7. The PLC device in claim 6, wherein the predetermined separation is 250 μm.

8. The PLC device in claim 6, wherein the predetermined separation is 127 μm.

9. A planar lightwave circuit (PLC) apparatus, comprising:
a PLC chip comprising a first optical waveguide, a plurality of second optical waveguides and an optical splitter connecting the first optical waveguide and the second optical waveguides;
a fiber array block (FAB) connected to one side of the PLC chip; and
a sealing case comprising an opening, the sealing case enclosing the PLC chip and exposing the FAB through the opening;
wherein the first optical waveguide and the plurality of second optical waveguides are arranged on the same side of the PLC chip

10. The PLC apparatus in claim 9, further comprising:
a glue arranged on the opening to seal the opening.

11. The PLC apparatus in claim 9, further comprising:
a supporting mount arranged in the sealing case to support the PLC chip.

12. The PLC apparatus in claim 9, wherein the FAB comprises a plurality of parallel optical fibers, and the number of the parallel optical fibers is equal to the total number of the first optical waveguide and the second optical waveguides.

13. The PLC apparatus in claim 9, wherein the PLC chip is used as an optical splitter apparatus, and the first optical waveguide is an input end and the second optical waveguides are output ends.

14. The PLC apparatus in claim 9, wherein the PLC chip is used as an optical combiner apparatus, and the first optical waveguide is an output end and the second optical waveguides are input ends.

15. The PLC apparatus in claim 9, wherein two adjacent optical fibers in the first optical waveguide and the second optical waveguides have a predetermined separation.

16. The PLC apparatus in claim 15, wherein two adjacent optical fibers in the parallel optical fibers of the FAB have a separation equal to the predetermined separation.
